(19) United States
(12) Patent Application Publication
(10) Pub. No.: US 2026/0230505 A1
(43) Pub. Date: Aug. 6, 2026

(54) DETECTING FRAUDULENT WEBSITES OR WEBPAGES USING DATA-DRIVEN MODEL

(71) Applicant: RAPTORXAI PRIVATE LIMITED, Tellapur (IN)

(72) Inventor: Pratyusha Vemuri Venkata, Tellapur (IN)

(21) Appl. No.: 19/119,700

(22) PCT Filed: Jul. 30, 2024
(86) PCT No.: PCT/IN2024/051412

§ 371 Date: Apr. 9, 2025

(30) Foreign Application Priority Data
Aug. 2, 2023 (IN) 202341052036

(51) Int. Cl. H04L 9/40

(52) U.S. Cl. CPC H04L 63/1483; H04L 63/1416

(57) ABSTRACT

The present disclosure provides a method for managing a fraudulent data item by an electronic device (100). The method includes obtaining a data item, where the data item includes at least one of a webpage and a website. Further, the method includes analysing a predetermined parameter associated with the data item to identify a fraudulent activity embedded in the data item using a data driven model. Further, the method includes storing and notifying the fraudulent activity embedded in the data item.

### FIELD OF THE INVENTION

The present disclosure relates to a content analysing method and system, and more specifically relates to a method and a system for detecting fraudulent websites using a data driven model (e.g., machine learning model, Artificial intelligence (AI) model or the like).

### BACKGROUND OF THE INVENTION

Information security and sensitivity are increasingly important as the need to detect and prevent violations of policies regarding the use, storage, or transmission of sensitive/private information has become a major area of concern in various places. Further, with rapid increase in digitization, cyber fraud has increased exponentially throughout the globe. Furthermore, in order to protect sensitive/private information, various methods and systems are used to classify a website and its associated content page, accessed via a uniform resource locator (URL), as fraudulent or genuine. However, existing systems and methods are not equipped to detect the sophisticated fraudulent websites prevalent in various places. Hence, there is still a need for an effective method and system to determine whether a website and its associated content page are genuine or not.

In light of the above-stated discussion, there is a need to overcome the above stated disadvantages.

### OBJECT OF THE DISCLOSURE

A principal object of the present disclosure is to provide a method and a system for detecting fraudulent websites using a data driven model.

Another object of the present disclosure is to analyse a predetermined parameter associated with a data item to identify a fraudulent activity embedded in the data item using the data driven model, where the data item includes at least one of a webpage and a website.

Yet another object of the present disclosure is to store and notify the fraudulent activity embedded in the data item.

Yet another object of the present disclosure is to mark and notify the URL as potentially fraud, when a URL count meets a threshold number.

Yet another object of the present disclosure is to transmit the marked URL to a legal authority associated with another electronic device.

Yet another object of the present disclosure is to add a potentially suspicious bias to an internet protocol (IP) address upon determining that a user of the electronic device visits a fraudulent website.

Yet another object of the present disclosure is to include the potentially suspicious bias into a final fraud score for a flagged IP address.

Yet another object of the present disclosure is to flag the user visited site as potentially fraudulent when the price of a predefined number of products in a user visited website is below a threshold value compared to the median genuine price of same number of products.

### SUMMARY OF THE INVENTION

Accordingly, the present disclosure provides a method for managing a fraudulent data item. The method includes obtaining, by an electronic device, at least one data item, where the data item includes at least one of a webpage and a website. Further, the method includes analysing, by the electronic device, at least one predetermined parameter associated with the at least one data item to identify at least one fraudulent activity embedded in the at least one data item using a data driven model. Further, the method includes storing and notifying, by the electronic device, the at least one fraudulent activity embedded in the at least one data item.

In an embodiment, the at least one predetermined parameter comprises at least one of: content in the at least one data item, a user behaviour, a network activity, a domain of the at least one data item, a WHOIS information, an life span of the domain, an empty Domain Name System (DNS) record, a traffic of the at least one data item, a page ranking value, an information of indexing of webpage by a service provider, a number of links pointing to the at least one data item, a presence of a host belonging to a top phishing internet service provider, a top phishing domain, an address bar comprising at least one special symbol, a period of expiry of the domain, a favicon, a preferred status of a port, an abnormal based feature, a Hypertext Markup Language (HTML) feature, and a JavaScript based feature.

In an embodiment, the abnormal based feature comprises at least one of a request URL, an anchor associated with the URL, URL, a meta tag, a script tag, a link tag, Server Form Handler (SFH) comprising an empty string, and a presence of a mail function.

In an embodiment, at least one of the HTML feature and JavaScript based feature comprises a number of times a webpage redirected to a webpage, status bar customization, a disabled right click feature, a pop-up window with a text field, and an i-frame feature.

In an embodiment, at least one fraudulent activity embedded with at least one data item is notified to at least one of a user and a server.

Accordingly, the present disclosure provides a method for managing a fraudulent data item. The method includes obtaining and storing, by an electronic device, an information of at least one URL when the URL is flagged as fraud by a user. Further, the method includes storing, by the electronic device, a count of fraud reports flagged by the user. Further, the method includes marking and notifying, by the electronic device, the URL as potentially fraud, when the count meets a threshold number.

In an embodiment, the method includes transmitting, by the electronic device, the marked URL to a legal authority associated with another electronic device.

Accordingly, the present disclosure provides a method for managing a fraudulent data item. The method includes identifying, by an electronic device, an internet protocol (IP) address of a fraudulent website. Further, the method includes flagging, by the electronic device, the IP addresses in a server. Further, the method includes adding, by the electronic device, a potentially suspicious bias to the IP address upon determining that a user of the electronic device visits the fraudulent website. Further, the method includes including, by the electronic device, the potentially suspicious bias into a final fraud score for the flagged IP address.

Accordingly, the present disclosure provides a method for managing a fraudulent data item. The method includes obtaining, by an electronic device, a price of at least one product from a plurality of websites. Further, the method includes computing, by the electronic device, a median genuine price associated with at least one product. Further, the method includes flagging, by the electronic device, the user visited site as potentially fraudulent when the price of a predefined number of products in the user visited website is below a threshold value compared to the median genuine price of same number of products.

Accordingly, the present disclosure provides an electronic device including a fraudulent data item handling controller coupled with a processor and a memory. The fraudulent data item handling controller is configured to obtain at least one data item, wherein the data item comprises at least one of a webpage and a website. Further, the fraudulent data item handling controller is configured to analyse at least one predetermined parameter associated with the at least one data item to identify at least one fraudulent activity embedded in the at least one data item using a data driven model. Further, the fraudulent data item handling controller is configured to store and notify the at least one fraudulent activity embedded in the at least one data item.

Accordingly, the present disclosure provides an electronic device including a fraudulent data item handling controller coupled with a processor and a memory. The fraudulent data item handling controller is configured to obtain and store an information of at least one URL when the URL is flagged as fraud by a user. Further, the fraudulent data item handling controller is configured to store a count of fraud reports flagged by the user. Further, the fraudulent data item handling controller is configured to mark and notify the URL as potentially fraud, when the count meets a threshold number.

Accordingly, the present disclosure provides an electronic device including a fraudulent data item handling controller coupled with a processor and a memory. The fraudulent data item handling controller is configured to identify an internet protocol (IP) address of a fraudulent website. Further, the fraudulent data item handling controller is configured to flag the IP addresses in a server. Further, the fraudulent data item handling controller is configured to add a potentially suspicious bias to the IP address upon determining that a user of the electronic device visits the fraudulent website. Further, the fraudulent data item handling controller is configured to include the potentially suspicious bias into a final fraud score for the flagged IP address.

Accordingly, the present disclosure provides an electronic device including a fraudulent data item handling controller coupled with a processor and a memory. The fraudulent data item handling controller is configured to obtain a price of at least one product from a plurality of websites. Further, the fraudulent data item handling controller is configured to compute a median genuine price associated with at least one product. Further, the fraudulent data item handling controller is configured to flag the user visited site as potentially fraudulent when the price of a predefined number of products in the user visited website is below a threshold value compared to the median genuine price of same number of products.

These and other aspects herein will be better appreciated and understood when considered in conjunction with the following description and the accompanying drawings. It should be understood, however, that the following descriptions are given by way of illustration and not of limitation. Many changes and modifications may be made within the scope of the invention herein without departing from the spirit thereof.

### BRIEF DESCRIPTION OF DRAWINGS

The invention is illustrated in the accompanying drawings, throughout which like reference letters indicate corresponding parts in the drawings. The invention herein will be better understood from the following description with reference to the drawings, in which:

FIG. 1 shows various hardware components of an electronic device.

FIG. 2 illustrates a system for managing a fraudulent data item.

FIG. 3 is a flow chart illustrating a method for managing the fraudulent data item.

FIG. 4 is a flow chart illustrating a method for managing the fraudulent data item based on a URL behavior.

FIG. 5 is a flow chart illustrating a method for managing the fraudulent data item upon identifying an IP address of a fraudulent website.

FIG. 6 is a flow chart illustrating a method for managing the fraudulent data item upon obtaining price of products from a plurality of websites.

FIG. 7 is an example illustration in which the electronic device identifies the fraudulent data item upon determining an IP address used as an alternative of a domain name in a URL.

FIG. 8 is an example illustration in which the electronic device identifies the fraudulent data item by detecting a transformation of the IP address into a hexadecimal code.

FIG. 9 is an example illustration in which the electronic device identifies the fraudulent data item by detecting a website address including a long URL IP address.

FIG. 10 is an example illustration in which the electronic device identifies the fraudulent data item by detecting the website address including a small URL.

FIG. 11 and FIG. 12 are example illustrations in which the electronic device identifies the fraudulent data item by detecting the website address including a special symbol.

### DETAILED DESCRIPTION

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in detail so as not to unnecessarily obscure aspects of the invention.

Furthermore, it will be clear that the invention is not limited to these alternatives only. Numerous modifications, changes, variations, substitutions and equivalents will be apparent to those skilled in the art, without parting from the scope of the invention.

The accompanying drawings are used to help easily understand various technical features and it should be understood that the alternatives presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The present disclosure achieves a method for managing a fraudulent data item. The method includes obtaining, by an electronic device, at least one data item, where the data item includes at least one of a webpage and a website. Further, the method includes analysing, by the electronic device, at least one predetermined parameter associated with the at least one data item to identify at least one fraudulent activity embedded in the at least one data item using a data driven model. Further, the method includes storing and notifying, by the electronic device, at least one fraudulent activity embedded in at least one data item.

Unlike existing methods, the proposed method accurately identifies and flags fraudulent websites using a data-driven model, thereby helping businesses and individuals stay protected from online fraud and scams. The method scans websites and analyses various factors such as content, user behaviour, and network activity to detect patterns and anomalies that may indicate fraudulent activity. Based on this approach, the electronic device is designed to be highly accurate and efficient, providing real-time alerts to users when a fraudulent website is detected. By utilizing the proposed method, businesses and individuals can safeguard themselves from financial and reputational harm caused by fraudulent websites. The method can quickly and accurately identify fraudulent websites.

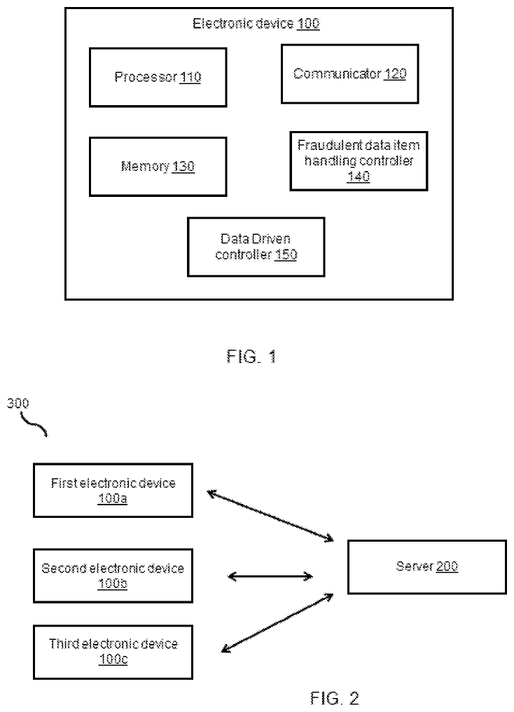

FIG. 1 shows various hardware components of the electronic device (100). The electronic device (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, a server, and an internet of things (IoT) device. In an embodiment, the electronic device (100) includes a processor (110), a communicator (120), a memory (130), a fraudulent data item handling controller (140), and a data driven controller (150). The processor (110) communicates with the communicator (120), the memory (130), the fraudulent data item handling controller (140), and the data driven controller (150).

The fraudulent data item handling controller (140) obtains a data item, where the data item includes at least one of a webpage and a website. Further, the fraudulent data item handling controller (140) analyses a predetermined parameter associated with the data item to identify a fraudulent activity embedded in the data item using a data driven model (ML model, AI model or the like).

The predetermined parameter can be, for example, but not limited to a content in the data item, user behaviour, network activity, domain of the data item, WHOIS information, lifespan of the domain, an empty Domain Name System (DNS) record, traffic of the data item, a page ranking value, an information of indexing of webpage by a service provider, a number of links pointing to the data item, presence of a host belonging to a top phishing internet service provider, a top phishing domain, an address bar comprising a special symbol, a period of expiry of the domain, a favicon, a preferred status of a port, abnormal based feature, a Hypertext Markup Language (HTML) feature, and a JavaScript based feature.

The abnormal based feature can be, for example, but not limited to a request URL, an anchor associated with the URL, URL, a meta tag, a script tag, a link tag, Server Form Handler (SFH) comprising an empty string, and presence of a mail function. The HTML feature and the JavaScript based feature can be, for example, but not limited to a number of times a webpage redirected to a webpage, status bar customization, a disabled right click feature, a pop-up window with a text field, and an i-frame feature.

Further, the fraudulent data item handling controller (140) stores and notifies the fraudulent activity embedded in the data item to a user or a server (200) (as shown in FIG. 2).

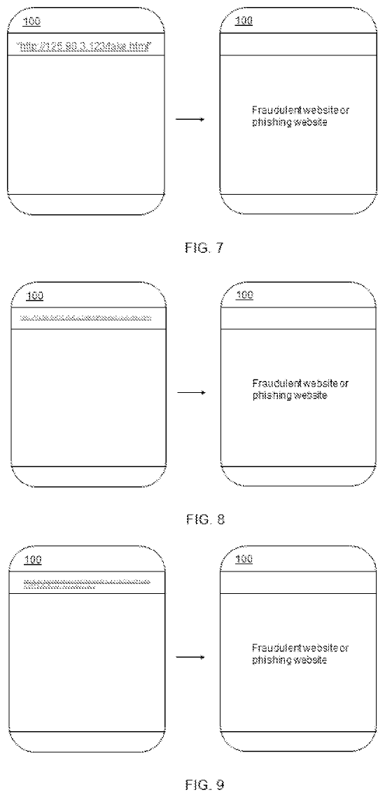

In an example (as shown in FIG. 7), the fraudulent data item handling controller (140) detects that the IP address is used as an alternative of the domain name in the URL (e.g., “http://125.98.3.123/fake.html”) then, the fraudulent data item handling controller (140) can be sure that someone is trying to steal their personal information. In another example, the fraudulent data item handling controller (140) detects that the domain part has an IP Address then, the fraudulent data item handling controller (140) notifies that the website is a fraudulent website or a phishing website.

As shown in FIG. 8, sometimes, the IP address is even transformed into a hexadecimal code as shown in the following link “http://0x58.0xCC.0xCA.0x62/2/paypal.ca/index.html”. The fraudulent data item handling controller (140) detects that the domain part has an IP address in the form of hexadecimal code then, the fraudulent data item handling controller (140) notifies that the website is the fraudulent website or the phishing website.

In another example (as shown in FIG. 9), the fraudulent data item handling controller (140) determines that the domain part or the website address has a long URL IP address then, the fraudulent data item handling controller (140) notifies that the website is the fraudulent website or the phishing website. For example, the fraudulent data item handling controller (140) determines that the domain part or the website address has http://federmacedoadv.com.br/3f/aze/ab51e2e319e51502f416dbe46b773a5 e/?cmd=_home&amp;disp or atch=11004d58f5b74f8dc1e7c2e8dd4105e811004d58f5b74f8dc1e7c2e8dd4 105e8@phishing.website. html then, the fraudulent data item handling controller (140) notifies that the website is a fraudulent website or the phishing website. The length of the URL is determined and set by the user of the electronic device (100). In an example, if the length of the URL is within 50 characters then, the fraudulent data item handling controller (140) determines that the website is genuine. In an example, if the length of the URL is not within 50 characters then, the fraudulent data item handling controller (140) determines that the website is the fraudulent website or the phishing website. The fraudulent data item handling controller (140) sets a rule for the length of the URL. For example, if the length of the URL is within 50 characters then, the fraudulent data item handling controller (140) determines that the website is genuine. If the length of the URL is within 50 characters to 100 characters then, the fraudulent data item handling controller (140) determines that the website is suspicious. If the length of the URL is more than 100 characters then, the fraudulent data item handling controller (140) determines that the website is the fraudulent website or the phishing website. The length of the URL is dynamically set based on the real time scenario.

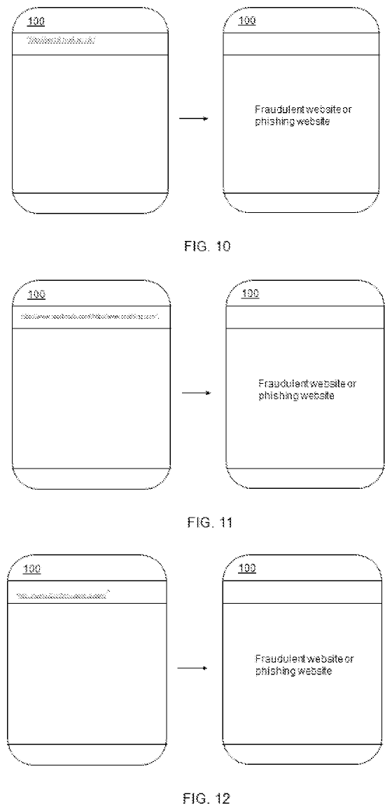

In an example (as shown in FIG. 10), the fraudulent data item handling controller (140) determines that the domain part or the website address has a small URL by using a URL shortening service. URL shortening is a technique on the “World Wide Web” in which a URL may be made considerably smaller in length and still lead to the required webpage. This is accomplished by means of an “HTTP Redirect” on a domain name that is short, which links to the webpage that has a long URL. For example, the URL “http://portal.hud.ac.uk/” can be shortened to “bit.ly/19DXSk4”. If the fraudulent data item handling controller (140) determines the TinyURL in the website address then, the website is the fraudulent website or the phishing website.

In another example (as shown in FIG. 11 and FIG. 12), the fraudulent data item handling controller (140) determines that the URL includes a special symbol. The special symbol can be, for example, but not limited to “@”, $, !, “//”, “-”. In an example, using “@” symbol in the URL leads the browser to ignore everything preceding the “@” symbol and the real address often follows the “@” symbol. When the fraudulent data item handling controller (140) determines that the URL includes a special symbol then, the website is the fraudulent website or the phishing website.

The existence of “//” within the URL path means that the fraudulent data item handling controller (140) will be redirected to another website. An example of such an URL is: “http://www.legitimate.com//http://www.phishing.com”. The fraudulent data item handling controller (140) examines the location where “//” appears. The fraudulent data item handling controller (140) finds that if the URL starts with “HTTP”, that means “//” should appear at the sixth position. However, if the URL employs “HTTPS” then “//” should appear at the seventh position.

The dash symbol is rarely used in legitimate URLs. Phishers tend to add prefixes or suffixes separated by (-) to the domain name so that users feel that they are dealing with a legitimate website. For example http://www.Confirme-paypal.com/. In this example, the fraudulent data item handling controller (140) determines that the URL includes a special symbol (“-”) therefore notifies that the website is the fraudulent website or the phishing website.

Let's consider that, the fraudulent data item handling controller (140) receives the following link such as http://www.hud.ac.uk/students/. A domain name includes country-code top-level domains (ccTLD), which in the example is “uk”. The “ac” part is shorthand for “academic”, the combined “ac.uk” is called a second-level domain (SLD) and “hud” is the actual name of the domain. To produce a rule for extracting this feature, the fraudulent data item handling controller (140) firstly has to omit the (www.) from the URL which is in fact a sub domain in itself. Then, the fraudulent data item handling controller (140) have to remove the (ccTLD) if it exists. Finally, the fraudulent data item handling controller (140) counts the remaining dots. If the number of dots is greater than one, then the URL is classified as “suspicious” since the URL has one sub domain. However, if the dots are greater than two, it is classified as “phishing” since it will have multiple sub domains. Otherwise, if the URL has no sub domains, the fraudulent data item handling controller (140) will assign “legitimate” to the feature. In simple words, the fraudulent data item handling controller (140) determines that the number of dots in the domain part is more than 1 then, the website is the fraudulent website or the phishing website.

In an embodiment, the fraudulent data item handling controller (140) determines whether the website is the fraudulent website or the phishing website or the legitimate website by using a HyperText Transfer Protocol (HTTPS) with secure sockets layer (SSL). In other words, the fraudulent data item handling controller (140) determines whether the website is the fraudulent website or the phishing website or the legitimate website by checking and analysing a certificate assigned with HTTPS including an extent of a trust certificate issuer, and a certificate age. The trust certificate issuer can be, for example, but not limited to GeoTrust®, GoDaddy®, Network Solutions®, Thawte®, Comodo®, Doster®, VeriSign® or the like. The certificate age is set by the electronic device (100). In an example, the minimum age of the reputable certificate is two years.

In another embodiment, the fraudulent data item handling controller (140) determines whether the website is the fraudulent website or the phishing website or the legitimate website by checking a domain registration length or domain registration duration. In an example, the fraudulent data item handling controller (140) determines that the longest fraudulent domain is used for a maximum of one year only. The domain registration length or the domain registration duration is determined based on a predefined condition set by the electronic device (100). For example, if the domain registration duration is less than 15 days then, the fraudulent data item handling controller (140) determines that the website is the fraudulent website or the phishing website.

In another embodiment, the fraudulent data item handling controller (140) determines whether the website is the fraudulent website or the phishing website or the legitimate website by checking a favicon. The favicon is a graphic image (icon) associated with a specific webpage in the website. User agents such as graphical browsers and newsreaders show the favicon as a visual reminder of the website identity in the address bar. If the favicon is loaded from a domain other than that shown in the address bar, then the webpage is likely to be considered the phishing attempt related website.

In yet another embodiment, the fraudulent data item handling controller (140) determines whether the website is the fraudulent website or the phishing website or the legitimate website by using a non-standard port. The non-standard port is used in validating if a particular service (e.g. HTTP or the like) is up or down on the server (200). In the aim of controlling intrusions, it is much better to merely open ports that the user needs. Several firewalls, Proxy and Network Address Translation (NAT) servers will, by default, block all or most of the ports and only open the ones selected. If all ports are open, phishers can run almost any service they want and as a result, user information is threatened. The most important ports and their preferred status are shown in Table 1.

TABLE 1

| | | | Preferred |
|---|---|---|---|
| PORT | Service | Meaning | Status |
| 21 | FTP | Transfer files from one host to another | Close |
| 22 | SSH | Secure File Transfer Protocol | Close |
| 23 | Telnet | Provide a bidirectional interactive text- | Close |
| | | oriented communication | |
| 80 | HTTP | Hypertext transfer protocol | Open |
| 443 | HTTPS | Hypertext transfer protocol secured | Open |
| 445 | SMB | Providing shared access to files, | Close |
| | | printers, serial ports | |
| 1433 | MSSQL | Store and retrieve data as requested | Close |
| | | by other software applications | |
| 1521 | ORACLE | Access oracle database from web. | Close |
| 3306 | MySQL | Access MySQL database from the web. | Close |
| 3389 | Remote | Allow remote access and remote | Close |
| | Desktop | collaboration | |

In yet another embodiment, the fraudulent data item handling controller (140) determines whether the website is the fraudulent website or the phishing website or the legitimate website by using the existence of an HTTPS token in the domain part of the URL. The phishers may add the “HTTPS” token to the domain part of the URL in order to trick users. For example, http://https-www-paypal-it-webapps-mpp-home.soft-hair.com/.

In yet another embodiment, the fraudulent data item handling controller (140) determines whether the website is the fraudulent website or the phishing website or the legitimate website by using a request URL technique. The request URL technique examines and analyses whether external objects contained within the webpage such as images, videos and sounds are loaded from another domain or the same domain. In legitimate webpages, the webpage address and most of the objects embedded within the webpage share the same domain. In a fraudulent website or a phishing website or a webpage, the webpage address and most of the objects embedded within the webpage do not share the same domain.

In yet another embodiment, the fraudulent data item handling controller (140) determines whether the website is the fraudulent website or the phishing website or the legitimate website by using an anchor. The anchor is an element or feature defined by a <a> tag in the URL. The anchor is treated exactly as “Request URL”. However, for the anchor, the fraudulent data item handling controller (140) examines if the <a> tags and the website have different domain names. This is similar to the request URL feature.

In an example, if the anchor does not link to any webpage, e.g. <a href=“#”>, <a href=“#content”>, <a href=“#skip”>, <a href=“JavaScript::void(0)”>, then the website is considered as the fraudulent website or the phishing website.

In yet another embodiment, the fraudulent data item handling controller (140) determines whether the website is the fraudulent website or the phishing website or the legitimate website by checking and analysing <Meta> tags, <Script> tags, and <Link> tags. Based on the proposed method, the fraudulent data item handling controller (140) determines that it is common for the legitimate websites to use <Meta> tags to offer metadata about the HTML document, the <Script> tags to create a client side script, and the <Link> tags to retrieve other web resources. It is expected that these tags are linked to the same domain of the webpage. If the tags are linked to the same domain of the webpage then, the website is the legitimate website. If the tags are not linked to the same domain of the webpage then, the website is the fraudulent website or the phishing website.

In yet another embodiment, the fraudulent data item handling controller (140) determines whether the website is the fraudulent website or the phishing website or the legitimate website by using Server Form Handler (SFH). The SFH including an empty string or “about: blank” are considered as doubtful since an action is taken upon a submitted information. In addition, if the domain name in the SFH is different from the domain name of the webpage, this reveals that the webpage is suspicious because the submitted information is rarely handled by external domains.

In yet another embodiment, the fraudulent data item handling controller (140) determines whether the website is the fraudulent website or the phishing website or the legitimate website by using the “mailto:” function. In an example, the web form allows the user to submit his/her personal information that is directed to the server (200) for processing. The phisher might redirect the user's information to his/her personal email using the “mailto:” function. If the fraudulent data item handling controller (140) detects the “mailto:” function. In the server-side script language then, the website is considered as the fraudulent website or the phishing website.

In yet another embodiment, the fraudulent data item handling controller (140) determines whether the website is the fraudulent website or the phishing website or the legitimate website by using an abnormal URL feature. The abnormal URL feature can be extracted from a WHOIS database (not shown).

In yet another embodiment, the fraudulent data item handling controller (140) determines whether the website is the fraudulent website or the phishing website or the legitimate website by using the HTML and JavaScript based feature. The HTML and JavaScript based feature can be, for example, but not limited to a website forwarding feature, a status bar customization feature, a disabling right click feature, a pop-up window feature, an IFrame Redirection feature, or the like.

The website forwarding feature determines and distinguishes the phishing websites from legitimate ones by—how many times the website has been redirected. Based on the proposed method, the fraudulent data item handling controller (140) determines that the legitimate websites have been redirected one time max. But, the phishing websites containing the website forwarding feature have been redirected at least 3 times.

By using the status bar customization feature, the phishers can use JavaScript to show a fake URL in the status bar to the users. In order to extract the status bar customization feature, the fraudulent data item handling controller (140) analyses a webpage source code, particularly using an “onMouseOver” event, and the fraudulent data item handling controller (140) checks and determines if it makes any changes to the status bar.

By using the disabling right click feature, the phishers use the JavaScript to disable the right-click function, so that the users cannot view and save the webpage source code. This feature is treated exactly as “Using onMouseOver to hide the Link”. In order to identify the disabling right click feature, the fraudulent data item handling controller (140) analyses the webpage source code, particularly using an “event.button==2” event, and the fraudulent data item handling controller (140) checks and determines if the right click is disabled in the webpage source code.

It is unusual to find a legitimate website asking the users to submit their personal information through a pop-up window. On the other hand, the pop-up window feature has been used in some legitimate websites and its main goal is to warn users about the fraudulent activities or broadcast a welcome announcement, though no personal information is asked to be filled in through these pop-up windows.

The IFrame redirection feature is an HTML tag used to display an additional webpage into one that is currently shown. The phishers can make use of an “iframe” tag and make it invisible i.e., without frame borders. In this regard, the phishers make use of a “frameBorder” attribute which causes the browser to render a visual delineation.

In an embodiment, the fraudulent data item handling controller (140) determines whether the website is the fraudulent website or the phishing website or the legitimate website by using a domain based feature. The domain based feature can be, for example, but not limited to an age of a domain feature, a website traffic feature, a DNS record feature, a page rank feature, a Google index feature, a number of links pointing to page feature and a statistical-reports based feature.

The age of the domain feature can be extracted from the WHOIS database. In an example, most phishing websites live for a short period of time. By reviewing various dataset, the fraudulent data item handling controller (140) can find the minimum age of the legitimate domain, for example 6 months.

By using the DNS record feature, the fraudulent data item handling controller (140) determines that if the DNS record is empty or not found then the website is classified as “phishing”. In other ways, the fraudulent data item handling controller (140) determines that if the DNS record is not empty or found then the website is classified as “legitimate”.

The website traffic feature measures the popularity of the website by determining the number of visitors and the number of pages they visit. Based on the proposed method, if the domain has no traffic or is not recognized by the database, it is classified as “phishing”. Otherwise, it is classified as “suspicious”.

The page rank feature is a value ranging from “0” to “1”. The page rank feature indicates the user to measure and determines how important the webpage is on the Internet. A higher page rank value means that the webpage is more important.

The Google index feature examines whether the website is in Google's index or not. When the website is indexed by Google®, it is displayed on search results then, the website is genuine. Usually, the phishing webpages are merely accessible for a short period and as a result, many phishing webpages may not be found on the Google index. The number of links pointing to a page feature indicates its legitimacy level, even if some links are of the same domain. The statistical-reports based feature formulate numerous statistical reports on phishing websites at every given period of time.

In another embodiment, the fraudulent data item handling controller (140) obtains and stores the information of the URL when the URL is flagged as fraud by the user. Further, the fraudulent data item handling controller (140) stores the count of fraud reports flagged by the user. Further, the fraudulent data item handling controller (140) marks and notifies the URL as potentially fraud, when the count meets a threshold number. The threshold number is set by the user or the electronic device (100). In an example, if the threshold number reaches 20 then, the website is the phishing website.

In another embodiment, the fraudulent data item handling controller (140) identifies the IP address of the fraudulent website. Further, the fraudulent data item handling controller (140) flags the IP addresses in the server (200). Further, the fraudulent data item handling controller (140) adds the potentially suspicious bias to the IP address upon determining that the user of the electronic device (100) visits the fraudulent website. Further, the fraudulent data item handling controller (140) includes the potentially suspicious bias into a final fraud score for the flagged IP address. The final fraud score indicates the behaviour of the phishing/fraudulent webpage. In an example, depending on weightage of each of the feature, the final fraud score is computed by the machine learning technique(s). Example is a website called kaalifashion.com, which is given a risk score of 96 which means that the website is very bad.

In another embodiment, the fraudulent data item handling controller (140) obtains the price of the product from the plurality of websites (e.g., Flipkart®, Snapdeal®, Amazon® or the like). Further, the fraudulent data item handling controller (140) computes the median genuine price associated with the product. Further, the fraudulent data item handling controller (140) flags the user visited site as potentially fraudulent when the price of a predefined number of products in the user visited website is below a threshold value compared to the median genuine price of the same number of products. In an example, a smartphone on Flipkart® and Amazon® is for Rs 40, 000and 41, 000 respectively, whereas another website shows the same phone for Rs 10000. Then, the other website is the fraudulent website.

The fraudulent data item handling controller (140) may implement analog and/or digital circuits such as logic gates, integrated circuits, microprocessors, microcontrollers, memory circuits, passive electronic components, active electronic components, optical components, hardwired circuits and the like, and may optionally be driven by firmware.

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard disks, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Further, at least one of the plurality of modules/controllers may be implemented through the AI model/ML model using the data driven controller (150). The data driven controller (150) can be an ML or AI model based controller. A function associated with the AI model may be performed through the non-volatile memory, the volatile memory, and the processor (110). The processor (110) may include one or a plurality of processors. The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to the present invention is performed, and/or may be implemented through a separate server/system.

The AI model may comprise a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 1 shows various hardware components of the electronic device (100) but it is to be understood that other embodiments are not limited thereon. In other embodiments, the electronic device (100) may include less or more number of components. Further, the labels or names of the components are used only for illustrative purposes and do not limit the scope of the invention. One or more components can be combined together to perform the same or substantially similar function in the electronic device (100).

FIG. 2 illustrates a system (300) for managing a fraudulent data item. In an embodiment, the system (300) includes a first electronic device (100a), a second electronic device (100b), a third electronic device (100c), and a server (200). The first electronic device (100a), the second electronic device (100b), and the third electronic device (100c) communicate with the server (200). The server (200) can be, for example, but not limited to an edge server, a central server, a cloud server, a block chain assisted server or the like. Hereinafter, the label of the electronic device is 100. In an embodiment, the server (200) may act as the electronic device (100).

The electronic device (100) performs all the functions of the fraudulent data item handling controller (140) as described above, which are excluded herein for sake of brevity or to avoid redundancy.

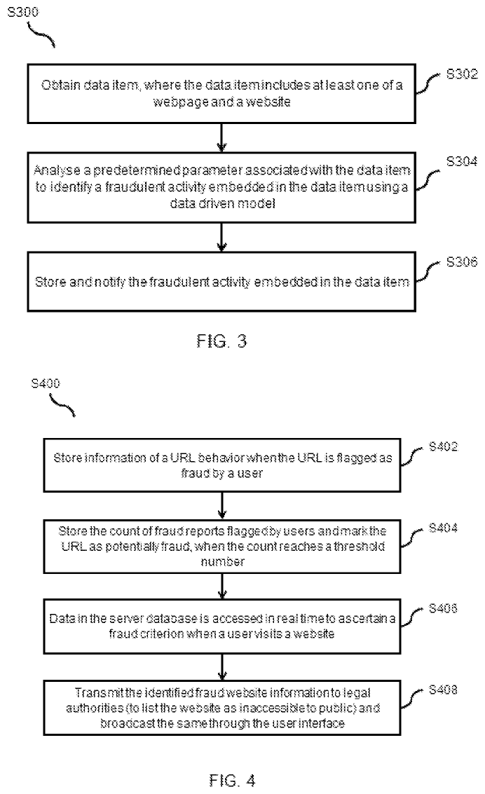

FIG. 3 is a flow chart (S300) illustrating a method for managing the fraudulent data item. The operations (S302-S306) are handled by the fraudulent data item handling controller (140).

At step S302, the method includes obtaining the data item, where the data item includes at least one of the webpage and the website. At step S304, the method includes analyzing the predetermined parameter associated with the data item to identify the fraudulent activity embedded in the data item using the data driven model. At S306, the method includes storing and notifying the fraudulent activity embedded in the data item.

FIG. 4 is a flow chart (S400) illustrating a method for managing the fraudulent data item based on the URL behavior. The operations (S402-S408) are handled by the fraudulent data item handling controller (140).

At S402, the method includes storing the information of the URL behaviour when the URL is flagged as fraud by the user. At S404, the method includes storing the count of fraud reports flagged by the users and marking the URL as potentially fraud, when the count reaches the threshold number. The threshold number is set by the user of the electronic device (100). At S406, the method includes accessing the data in a server database (e.g., sync server database (not shown)) in real time to ascertain a fraud criterion when the user visits the website. At S408, the method includes transmitting the identified fraud website information to legal authorities (to list the website as inaccessible to the public) and broadcasting the same through a user interface of the electronic device (100).

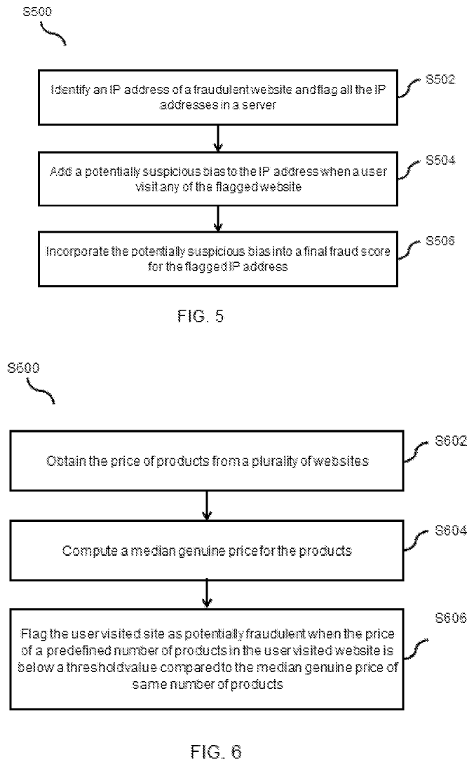

FIG. 5 is a flow chart (S500) illustrating a method for managing the fraudulent data item upon identifying the IP address of the fraudulent website. The operations (S502-S506) are handled by the fraudulent data item handling controller (140).

At S502, the method includes identifying the IP address of the fraudulent website and flagging all the IP addresses in the server (200). At S504, the method includes adding the potentially suspicious bias to the IP address when the user visits any of the flagged websites. At S506, the method includes incorporating the potentially suspicious bias into the final fraud score for the flagged IP address.

FIG. 6 is a flow chart (S600) illustrating a method for managing the fraudulent data item upon obtaining the price of products from the plurality of websites. The operations (S602-S606) are handled by the fraudulent data item handling controller (140).

At S602, the method includes obtaining the price of products from the plurality of websites, i.e., from the user visited potentially fraud website and from other genuine sites (e.g.: Amazon or the like). At S604, the method includes computing the median genuine price for the products. At S606, the method includes flagging the user visited site as potentially fraudulent when the price of the predefined number of products in the user visited website is below a threshold value as compared to the median genuine price of the same number of products.

The various actions, acts, blocks, steps, or the like in the flow chart (S300-S600) may be performed in the order presented, in a different order or simultaneously. Further, in some implementations, some of the actions, acts, blocks, steps, or the like may be omitted, added, modified, skipped, or the like without departing from the scope of the invention.

The embodiments disclosed herein can be implemented using at least one software program running on at least one hardware device and performing network management functions to control the elements.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope of the invention. It is intended that the specification and examples be considered as exemplary, with the true scope of the invention being indicated by the claims.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain alternatives include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain alternatives require at least one of X, at least one of Y, or at least one of Z to each be present.

While the detailed description has shown, described, and pointed out novel features as applied to various alternatives, it can be understood that various omissions, substitutions, and changes in the form and details of the devices or algorithms illustrated can be made without departing from the scope of the disclosure. As can be recognized, certain alternatives described herein can be embodied within a form that does not provide all of the features and benefits set forth herein, as some features can be used or practiced separately from others.

What is claimed is:

1. A method for managing a fraudulent data item, comprising:
obtaining, by an electronic device, (100), at least one data item, wherein the data item comprises at least one of a webpage and a website;
analysing, by the electronic device, (100), at least one predetermined parameter associated with the at least one data item to identify at least one fraudulent activity embedded in the at least one data item using a data driven model; and
storing and notifying, by the electronic device, (100), the at least one fraudulent activity embedded in the at least one data item.

2. The method as claimed in claim 1, wherein the at least one predetermined parameter comprises at least one of: content in the at least one data item, user behaviour, network activity, a domain of the at least one data item, WHOIS information, lifespan of the domain, an empty Domain Name System (DNS) record, traffic of the at least one data item, a page ranking value, information of indexing of webpage by a service provider, a number of links pointing to the at least one data item, presence of a host belonging to a top phishing internet service provider, a top phishing domain, an address bar comprising at least one special symbol, a period of expiry of the domain, a favicon, a preferred status of a port, an abnormal based feature, a Hypertext Markup Language (HTML) feature, and a JavaScript based feature.

3. The method as claimed in claim 2, wherein the abnormal based feature comprises at least one of a request URL (Uniform Resource Locator), an anchor associated with the URL, URL, a meta tag, a script tag, a link tag, Server Form Handler (SFH) comprising an empty string, and presence of a mail function.

4. The method as claimed in claim 1, wherein at least one of the HTML feature and JavaScript based feature comprises a number of times a webpage redirected to a webpage, status bar customization, a disabled right click feature, a pop-up window with a text field, and an i-frame feature.

5. The method as claimed in claim 1, wherein at least one fraudulent activity embedded with at least one data item is notified to at least one of a user and a server.

6. A The method as claimed in claim 1,
wherein obtaining the at least one data item includes obtaining information of at least one URL (Uniform Resource Locator) when the URL is flagged as fraud by a user; and
wherein the method further comprises:
storing, by the electronic device, a count of fraud reports flagged by the user; and
marking by the electronic device, the URL as potentially fraud, when the count meets a threshold number.

7. The method as claimed in claim 6, wherein the method comprises transmitting, by the electronic device, the marked URL to a legal authority associated with another electronic device.

8. The method as claimed in claim 1, further comprising:
identifying, by the electronic device, (100), an internet protocol (IP) address of the website, the website being fraudulent;
flagging, by the electronic device, the IP address in a server;
adding, by the electronic device, potentially suspicious bias to the IP address upon determining that a user of the electronic device visits the website; and
including, by the electronic device, the potentially suspicious bias into a final fraud score for the flagged IP address.

9. The method as claimed in claim 1,
wherein obtaining, by the electronic device, the at least one data item includes obtaining-a price of at least one product from a plurality of websites, the plurality of websites including the website;
computing, by the electronic device, a median genuine price associated with the at least one product; and
flagging, by the electronic device, a user visited site as potentially fraudulent when the price of a predefined number of products in the user visited website is below a threshold value when compared to the median genuine price of same number of products.

10. An electronic device comprising:
a processor;
a memory; and
a fraudulent data item handling controller, coupled with the processor and the memory configured to:
obtain at least one data item, wherein the data item comprises at least one of a webpage and a website;
analyse at least one predetermined parameter associated with the at least one data item to identify at least one fraudulent activity embedded in the at least one data item using a data driven model; and
store and notify the at least one fraudulent activity embedded in the at least one data item.

11. The electronic device as claimed in claim 10, wherein the at least one predetermined parameter comprises at least one of: content in the at least one data item, user behaviour, network activity, a domain of the at least one data item, WHOIS information, life span of the domain, an empty Domain Name System (DNS) record, traffic of the at least one data item, a page ranking value, information of indexing of webpage by a service provider, a number of links pointing to the at least one data item, presence of a host belonging to a top phishing internet service provider, a top phishing domain, an address bar comprising at least one special symbol, a period of expiry of the domain, a favicon, a preferred status of a port, an abnormal based feature, a Hypertext Markup Language (HTML) feature, and a JavaScript based feature.

12. The electronic device as claimed in claim 11, wherein the abnormal based feature comprises at least one of a request URL (Uniform Resource Locator), an anchor associated with the URL, a meta tag, a script tag, a link tag, Server Form Handler (SFH) comprising an empty string, and presence of a mail function.

13. The electronic device as claimed in claim 11, wherein at least one of the HTML feature and JavaScript based feature comprises a number of times a webpage redirected to a webpage, status bar customization, a disabled right click feature, a pop-up window with a text field, and an i-frame feature.

14. The electronic device as claimed in claim 10, wherein at least one fraudulent activity embedded with at least one data item is notified to at least one of a user and a server.

15. The electronic device of claim 10, wherein,
the fraudulent data item handling controller
obtains and stores information of at least one URL (Uniform Resource Locator) when the URL is flagged as fraud by a user; and
wherein the fraudulent data item handling controller is further configured to:
store a count of fraud reports flagged by the user; and
mark and notify the URL as potentially fraud, when the count meets a threshold number.

16. The electronic device as claimed in claim 15, wherein the fraudulent data item handling controller is configured to transmit the marked URL to a legal authority associated with another electronic device.

17. (canceled)

18. The electronic device of claim 10, wherein (100), comprising:
the fraudulent data item handling controller is configured to:
obtain a price of at least one product from a plurality of websites;
compute a median genuine price associated with the at least one product; and
flag a user visited site as potentially fraudulent when the price of a predefined number of products in the user visited website is below a threshold value when compared to the median genuine price of same number of products.

19. An electronic device, comprising:
a processor;
a memory; and
a fraudulent data item handling controller, coupled with the processor and the memory, configured to:
identify an internet protocol (IP) address of a fraudulent website;
flag the IP address in a server;
add a potentially suspicious bias to the IP address upon determining that a user of the electronic device visits the fraudulent website; and
include the potentially suspicious bias into a final fraud score for the flagged IP address.
